(19) United States
(12) Patent Application Publication
(10) Pub. No.: US 2002/0088529 A1
(43) Pub. Date: Jul. 11, 2002

(54) Method for manufacturing pneumatic tire

(75) Inventors: Yuichiro Ogawa, Kodaira City (JP); Shuhei Iizuka, Kodaira City (JP)

Correspondence Address: OLIFF & BERRIDGE, PLC, P.O. BOX 19928, ALEXANDRIA, VA, 22320, US

(73) Assignee: BRIDGESTONE CORPORATION, Tokyo (JP)

(21) Appl. No.: 09/988,347

(22) Filed: Nov. 19, 2001

(30) Foreign Application Priority Data
Nov. 22, 2000 (JP) 2000-355,449
Dec. 28, 2000 (JP) 2000-400,918

(51) Int. Cl. B29C 35/00

(52) U.S. Cl. 156/128.6; 156/130.7; 156/165

(57) ABSTRACT

A pneumatic tire is highly precisely and efficiently manufactured by a method wherein, during formation of a green tire, at least one constitutive member, such as a sidewall (17), is formed by radially outwardly expanding a widthwise center portion of a substantially cylindrical carcass band (13), and subsequently winding an unvulcanized rubber strip and joining the rubber strip onto an outer peripheral surface of the expanded carcass band (13).

### BACKGROUND OF THE INVENTION

1. Field of the Invention

The present invention relates to a method for manufacturing a pneumatic tire, particularly a radial tire, which not only satisfies the requirements imposed on various tire constitutive elements in terms of shape and material, but also enables a highly precise formation thereof.

2. Description of the Related Art

Conventional, widely adopted method for manufacturing pneumatic tire comprises formation of a green tire by winding various tire constitutive members, which are made of rubber materials and pre-molded in the foregoing step, around a shaping drum one over another in orderly fashion for adhesive joining; and deforming those tire constitutive members into respectively predetermined shapes.

With increased demand for high performance tires in recent years, the requirement for tire constitutive members became stern and the shape of the members became complicated accordingly. When such tire constitutive members are wound around a tire shaping drum according to the conventional method, the precision with regard to the winding position tends to degrade, or irregularities tend to develop at the joints between different constitutive members wound around the tire shaping drum, because there may occur a significant difference in circumferential length between inner members and outer members both of which have a complicated form, and thus the uniformity and balance of the tire product may be impaired.

On the other hand, there is not infrequently a case where the tire constitutive members cannot be integrally formed into a unit to give a desired shape owing, for example, to the requirement imposed by the equipment of the preceding steps responsible for the pre-molding of those tire constitutive members. In such a case, the constitutive members are divided into a plurality of sub-units, which are separately pre-molded and assembled to give a tire with a desired shape. However, according to this method, the number of necessary units increases which in turn causes the number of steps introduced for winding constitutive members around a shaping drum and the number of joints observed on the shaping drum to increase. This not only lowers the efficiency in the formation of a green tire but also degrades the uniformity and balance of the tire.

Moreover, if a tire constitutive member has a laminated rubber structure composed of different rubber layers, the tire constitutive member pre-molded may have the risk of becoming unstable in its shape because of qualitative differences among those rubber layers.

### SUMMARY OF THE INVENTION

It is a primary object of the present invention to provide an improved method for manufacturing a pneumatic tire, which eliminates the above-mentioned problems of the prior art.

It would be highly desirable that the method according to the present invention makes it possible (i) to securely form tire constitutive elements which are pre-molded in a desired shape, into a desired shape at any given time, even when they are made of a plurality of rubber materials having different properties, without causing the number of necessary units to increase; (ii) to wind the tire constitutive members around a shaping drum without exposing them to the risk of being degraded in positioning precision due to the winding itself; (iii) to improve the efficiency of the work necessary involved in tire building, as well as the uniformity and balance of tire product; and/or (iv) to prevent the tire from being exposed to the risk of being degraded in performance due to possible existence of irregular joints between the tire constitutive members.

According to one aspect of the present invention, there is provided a method for manufacturing a pneumatic tire, wherein at least one kind of tire constitutive member, such as a bead filler, sidewall, rubber chafer, buffering rubber or belt undercushion, is formed on an outer peripheral side of a carcass band, said method comprising the steps, for forming a green tire, of: radially outwardly expanding a widthwise center portion of a substantially cylindrical carcass band; and winding and joining an unvulcanized rubber strip onto an outer peripheral surface of the expanded carcass band, thereby forming said tire constitutive member.

In this case, it is also possible to spirally wind two or more kinds of unvulcanized rubber strips in succession to form a tire constitutive member.

With the above-mentioned method according to the present invention, for example, an unvulcanized rubber strip 5-20 mm in width and 0.2-3 mm in thickness is wound round on the outer peripheral surface of a carcass band deformed in advance by expansion into a shape similar to that of a green tire, by being discharged from an extrusion machine, injection/extrusion machine or constant volume extrusion machine, laid one turn over another to form a lamination for serving as a necessary constitutive tire member. Therefore, even if the tire constitutive member is designed to have a complicated shape, it is possible to produce the tire constitutive member simply, easily and precisely without being restricted by the requirement imposed by the tire building equipment.

Further, because the method according to the present invention comprises directly winding round a strip onto the outer peripheral surface of tire, it allows the constitutive member to be positioned far more precisely than with the method wherein the previously molded constitutive member is applied by adhesion on the outer peripheral surface of tire, and irregularities at joints to be more effectively eliminated. As a consequence, the method according to the present invention makes it possible to significantly improve the efficiency of the work involved in tire building, as well as the uniformity and balance of the product tire.

In addition, with the method according to the present invention, because a strip is directly wound round onto the outer peripheral surface of the carcass band to form a tire constitutive member thereupon, it is possible to thoroughly eliminate the instability in form of the constitutive member even if the constitutive member is made of different rubber materials, because then the method allows winding strips of different materials one after another in succession.

It is preferred to vary the cross-sectional shape of a strip in accordance with the desired shape of the tire constitutive member the strip is made into, and to wind the strip such that, for each turn, a preceding turn is superimposed at least partially by a succeeding turn.

Through such procedure, it is possible to further improve the precision in terms of positioning of the tire constitutive member, and the uniformity thereof.

The above features also holds for a method wherein at least one kind of tire constitutive member, such as a tread, inter-belt cushion or tread under-cushion, is formed on an outer peripheral side of a carcass band, said method comprising the steps, for forming a green tire, of: radially outwardly expanding a widthwise center portion of a substantially cylindrical carcass band; applying a belt layer onto an outer peripheral surface of the expanded carcass band; and winding and joining at least one kind of unvulcanized rubber strip onto an outer peripheral surface of the belt layer, thereby forming said tire constitutive member.

The former method wherein a strip is wound round on the outer peripheral surface of an expanded carcass band, may be combined with the latter method wherein plural strips are wound round on the outer peripheral surface of a belt attached to an expanded carcass band, so as to further improve the uniformity and balance of the tire.

The present invention is also addressed to a method for manufacturing a pneumatic tire provided with an insert ply comprising reinforcing cords which extend in a desired region including a bead portion and a sidewall portion of the tire, approximately in parallel with the tire circumference direction.

There is known a method for forming a green tire having insert plies in its tire side portions, comprising, during a shaping procedure, deforming the center portion of a cylindrical carcass band by emphatically expanding it; bringing its crown portion into intimate contact with the inner face of a belt tread band previously molded into a circular form for joining; and then attaching by adhesion an insert ply composed of reinforcing cords to both side portions of carcass band separated from each other with the crown portion inserted therebetween.

However, the green tire formed by such a method poses a number of problems. Since the green tire has a low restricting force against the reinforcing cords of insert ply, the reinforcing cords extending in parallel with the circumferential direction may lose their tension in association with the deformation or spill of a rubber substance which may occur during vulcanization of the green tire, or may be deformed so much as to take wavy courses; and thus it may be difficult or even impossible to obtain a tire product after vulcanization where the reinforcing cords are given a desired tension as designed, that is, where the tire is shaped as designed.

It is therefore another object of the present invention to provide an improved method for manufacturing a pneumatic tire with insert plies, whereby reinforcing cords constituting an insert ply can be maintained at a desired position, so as to obtain a product tire with a desired shape as designed.

According to another aspect of the present invention, there is provided a method for manufacturing a pneumatic tire including insert plies in its sidewall portions, wherein said insert plies are formed on an outer peripheral side of a carcass band, said method comprising the steps, for forming the green tire, of: radially outwardly expanding a widthwise center portion of a substantially cylindrical carcass band having marginal portions to which bead rings are attached, by moving the bead rings axially toward each other; forming the insert plies by applying, on both side portions of the carcass band separated from each other with the center portion therebetween, reinforcing cords to extend approximately in parallel with the circumferential direction; and enhancing a degree of radial expansion of the carcass band by further moving the beard rings axially toward each other, so as to increase a tension of the reinforcing cords and thereby bring an outer face of a resultant crown portion into contact with a belt and a tread for joining.

With the above-mentioned method according to the present invention, after application of the insert plies, both bead rings are further moved axially towards each other, i.e., the foot width of carcass band is further narrowed. Since the cross-section of the carcass band has a constant length, all the side portion having the insert ply attached thereto is further expanded/deformed outward in the radial direction and a force is thereby developed which causes the insert ply, or more accurately the reinforcing cords to elongate their radius; and thus the tension of the reinforcing cords is increased as compared with the tension existent immediately after their application.

The reinforcing cords whose tension has been increased satisfactorily withstand forces resulting from the deformation/spill of rubber substance which may occur during the vulcanization of the green tire, so as to effectively maintain their positions and shape as initially determined. Thanks to this feature, it is possible to obtain a product tire after vulcanization, where the tension of reinforcing forces and the shape of product tire are maintained as designed.

If a method is introduced whereby an insert ply is obtained by continuously winding round a reinforcing cord on a side portion of a carcass band in an approximately spiral form, the method is preferable as compared with a method wherein an insert ply is prepared in advance, because with the former method, the need for management and storage of an insert ply can be dispensed with, and the risk of the spiral form of an insert ply being inadvertently modified can be safely avoided.

A more preferred variant of the method according to the present invention comprises increasing the expansion degree of carcass band, thereby causing the reinforcing cords to be forcibly embedded into a coating rubber constituting the carcass band.

With the method according to the present invention, undesired displacement and/or deformation of reinforcing cords, which may arise during vulcanization of a green tire, can be more positively prevented because the reinforcing cords are not only subject to an enhanced tension, but also firmly entrapped by the coating rubber, or in a broader sense by the carcass band.

### BRIEF DESCRIPTION OF THE DRAWINGS

The present invention will be described below with reference to preferred embodiments shown in the accompanying drawings.

FIGS. 1a and 1b are schematic views showing the method of manufacturing a pneumatic tire according to one embodiment of the present invention.

FIG. 2 is a schematic view showing the method of manufacturing a pneumatic tire according to another embodiment of the present invention.

FIGS. 3a, 3b and 3c are schematic views showing the method of manufacturing a pneumatic tire according to another embodiment of the present invention.

FIG. 4 is a schematic view showing the method of manufacturing a pneumatic tire according to another embodiment of the present invention.

FIG. 5 is a schematic view showing the method of manufacturing a pneumatic tire according to another embodiment of the present invention.

FIGS. 6a and 6b are schematic views showing the method of manufacturing a pneumatic tire according to another embodiment of the present invention.

FIG. 7 is a schematic view showing an example where a belt tread band is joined to a carcass.

FIGS. 8a and 8b are schematic views showing another example of the insert play.

FIGS. 9a and 9b are schematic views showing the reinforcing cords in a wavy state.

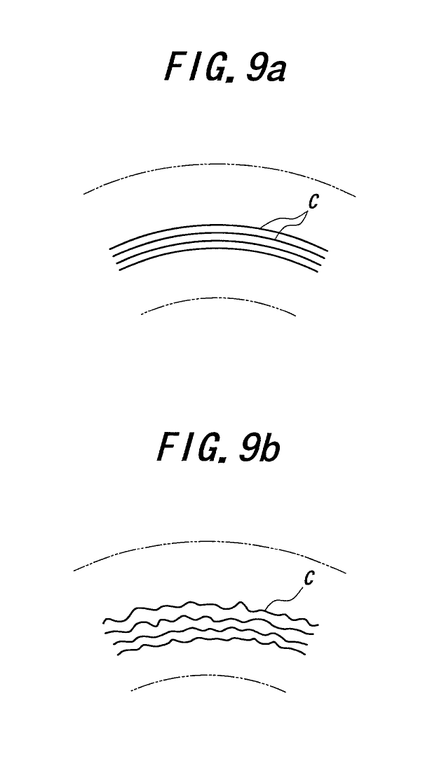

### DESCRIPTION OF THE PREFERRED EMBODIMENTS

According to the present invention, first of all, a carcass ply consisting of ply cords is applied to a carcass band drum in such a way as to cause the cords to extend in the circumferential direction of the drum, in order to deform the carcass ply into a cylindrical shape, thereby producing a carcass band. Then, for example, bead cores are attached to both marginal portions of this carcass band, and the marginal portions of carcass band are folded back around bead fillers and the bead cores.

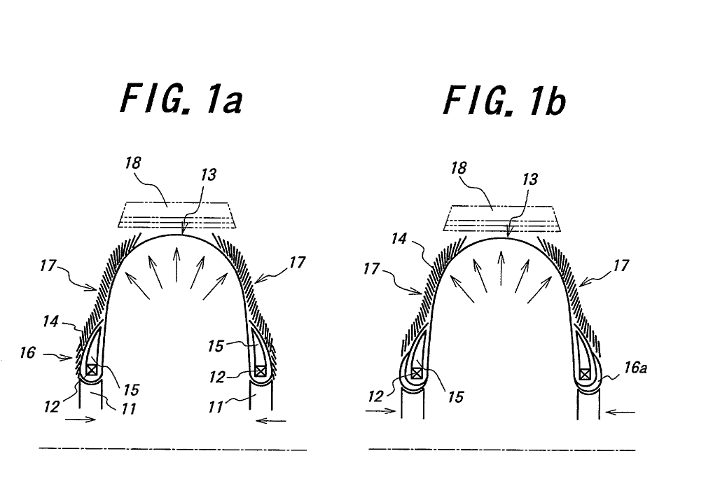

With regard to the carcass band configured as above, while it is applied to the carcass band drum or to other means such as a formalizing means, both bead rocks 1 are diverged from each other to elongate the radius as shown in FIGS. 1a and 1b to be stabilized there; a pressurized gas is fed directly, or indirectly via a bladder, into the space surrounded by the inner face of carcass band 13, thereby causing the center portion of carcass band 13 to expand outward in the radial direction under a circumstance where both bead rocks, or more accurately both bead cores 12 are being converged towards each other; in the above state, an unvulcanized rubber strip 14 whose material and dimension are appropriately chosen and which is extruded, for example, from a nozzle of an extrusion machine, is applied on the outer peripheral surface of carcass band by being spirally wound round once or plural times thereupon in such a way as to cause a preceding turn to be superimposed at least partially by a succeeding turn within a desired range along a circular direction; and thereby a tire constitutive member generally having a desired shape and dimension is obtained.

FIG. 1a shows a case where a rubber chafer 16 and a sidewall 17 are obtained by this method, that is, by winding round respective strips such that one turn is superimposed by another to form a lamination, excepting a bead filler which is positioned adjacent to the outer peripheral surface of bead core 12. FIG. 1b shows a case where the sidewall 17 is obtained by winding round a strip while the rubber chafer 16a is obtained by a conventional method including application of a band by adhesion.

After necessary tire constitutive members are formed as above, for example, increasing the degree of deformation by expansion of the carcass band 13, and bringing the crown portion thereof into intimate contact with a belt tread band 18 (to be referred to as a “BT band” hereinafter) which has been pre-molded to give a definitive dimension in its external and internal diameters, results in the formation of a completed green tire.

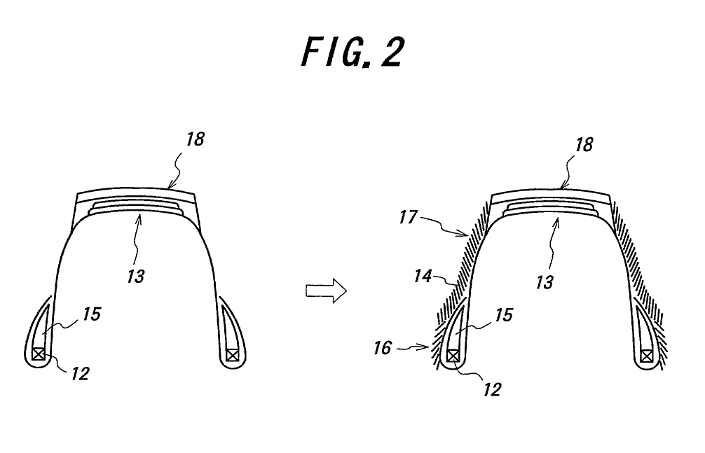

FIG. 2 shows a method whereby the center portion of carcass band 13 is intensively deformed by expansion to such an extent that the center portion comes in intimate contact with a BT band 18, before application of rubber chafer 16 and sidewall 17 to the carcass band is achieved by winding round respective unvulcanized rubber strips 14 thereupon. According to this method, the rubber chafer 16 and sidewall 17 are relieved of deformations associated with expansion which could otherwise occur if they were applied and then the expansion of the carcass band introduced. This will contribute to improve their shape and positioning precision.

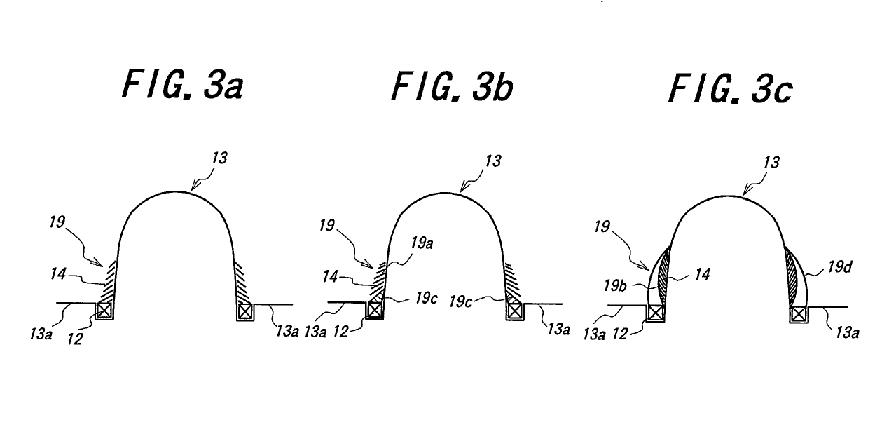

FIGS. 3a, 3b and 3c show an illustrative example where formation of a bead filler or a tire constitutive member is achieved by spirally winding round an unvulcanized rubber strip on the carcass band. FIG. 3a shows a case where formation of a bead filler 19 is achieved by winding round an unvulcanized rubber strip 14 on the outer peripheral portion close to a bead core 12, before the marginal portion 13a of carcass band 13 is folded back around the bead core 12.

In this case, the entire bead filler 19 may be made of one kind of rubber, or it may be made of two kinds of rubbers different, for example, in hardness or post-vulcanization properties.

FIGS. 3b and 3c show a case where, of a bead filler 19, a portion 19a located at a distal position and another portion 19b located at a proximal position in the radial direction are separately obtained by winding round respective unvulcanized rubber strips 14 while the remaining portions 19c and 19d are formed in advance by molding rubber materials the same or different with or from the above rubber materials into a desired shape.

According to any one of the above methods, if the marginal portion 13a of carcass band 13 is folded back around bead core 12, the bead filler 19 will be wrapped up together with bead core 12 into the marginal portion 13a.

The subsequent works may proceed according to the methods as discussed above with respect to FIGS. 1a, 1b or FIG. 2, or to the methods described later.

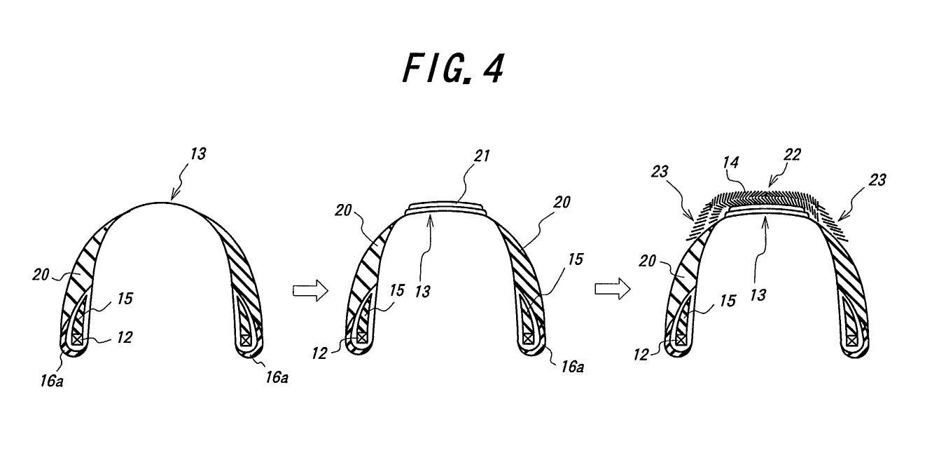

FIG. 4 shows a case where a bead filler 15, rubber chafer 16a and sidewall 20 all pre-molded are applied around a carcass band 13 by winding round those members thereupon to adhere thereto using a conventional technique; after the center portion of carcass band 13 is deformed by expansion until it is brought into intimate contact with the inner circular face of a belt layer ring 21 properly set in advance, an unvulcanized rubber strip 14 consisting of one or two kinds of rubber materials are applied to the outer peripheral face of the belt layer ring 21 by spirally winding round the rubber strip thereupon; and thus a tread 22 having a cap-base structure with conductive layers penetrating the cap and base in the radial direction is formed on the center portion of carcass band 23.

In this case, together with the formation of tread 22, formation of a mini-sidewall 23 for bridging the tread 22 and the sidewall 20 may be introduced by spirally winding round a strip on the relevant area. Alternatively, only the tread 22 may be formed. In the latter case, a pre-molded mini-sidewall may be added after the tread 22 has been formed.

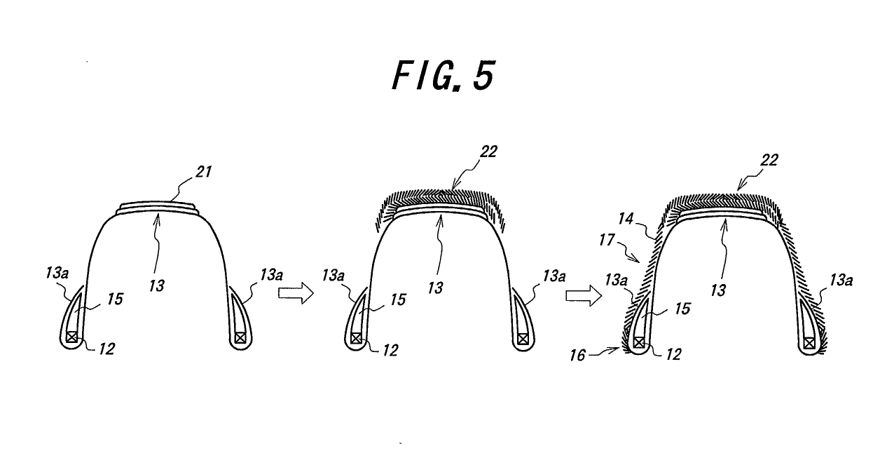

FIG. 5 shows a still further embodiment where the center portion of a carcass band 13 is intensively deformed by expansion so as to be brought into intimate contact with a belt layer ring 21 while its folded-back marginal portion 13a contains a bead core 12 and bead filler 15 in its folded-back portion; a belt 22 is formed by the method described above with respect to FIG. 4; then a sidewall 17 and a rubber chafer 16 are formed by the method described above with respect to FIG. 1a.

In this embodiment, it is also possible to form sidewall 17 and rubber chafer 16 before the formation of tread 22.

The preferred embodiments of the present invention have been described with reference to the accompanying figures. However, needless to say, the present invention also applies to the manufacture of a so-called bead coreless tire. Further, the tire constitutive member may include a buffer rubber to be applied on the carcass ply, and a belt undercushion to be inserted between the belt layer and the carcass band, and a tread undercushion to be inserted between the tread and the belt.

As discussed above, according to the present invention, it is possible to securely confer tire constitutive members with their respective desired shapes at all times, even if they are made of different kinds of rubber materials, by applying unvulcanized rubber strips having a desired dimension and made of materials satisfying given requirements, by spirally winding round them on a carcass band, without requiring an increased number of necessary parts therefor, and without exposing the members to the risk of becoming unstable in their shape. It is also possible to prevent lowering of positioning precision caused by the winding round of the tire constitutive element itself; to significantly improve the uniformity and balance of tire product as well as the work efficiency; and to satisfactorily prevent occurrence of impaired uniformity or balance which may arise as a result of irregularities at the joints between different constitutive members.

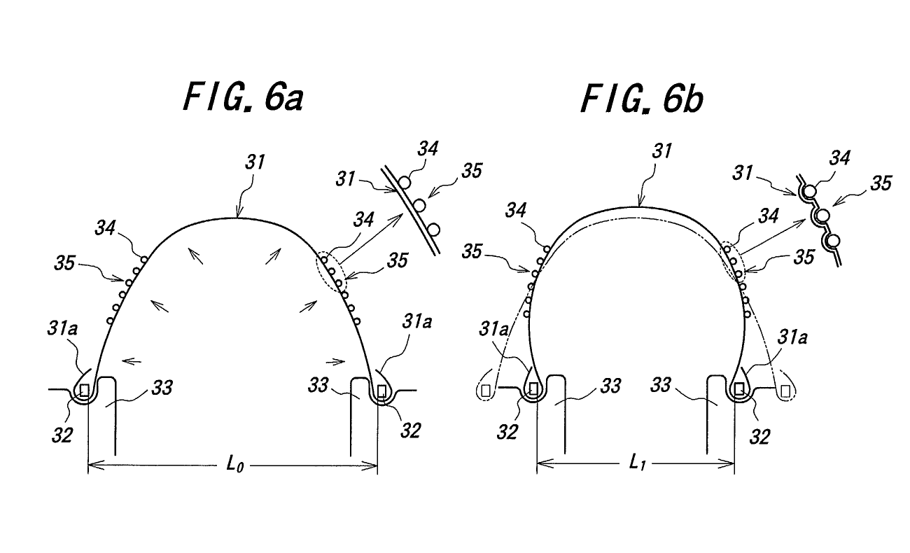

Further developments of the present invention well be described below with reference to the embodiments shown in FIGS. 6a and 6b et seq., which are applied to manufacturing of pneumatic tires having insert plies embedded in the sidewall portions.

FIGS. 6a and 6b are schematic views representing an embodiment of the present invention. Specifically, they are sectional views of a green tire undergoing a shaping process whereby the center portion of a carcass band is deformed by expansion. The deformation is achieved by a so-called single stage forming wherein a shaping drum which also serves as a carcass band shaping drum is used, or by a so-called double stage forming wherein a shaping drum distinct from a carcass band shaping drum is used.

A carcass band 31 is obtained by molding an unvulcanized ply with a carcass band shaping drum, not shown, into a cylindrical shape; two marginal portions are folded back around their respective bead rings 32 placed close thereto together with their respective inner liners not illustrated here to form respective folded-back portions 31a; two bead rings 32, or more directly two bead rocks 33 which support the bead rings on their inner circumferences are converged towards each other; and a pressurized gas is blown directly, or indirectly via a bladder, into the internal space of carcass band 31, such that the center portion extending in the circumferential direction is deformed, being expanded outward in the radial direction.

In this particular embodiment, expansion/deformation of the carcass band 31 is temporarily withdrawn at a time point when the distance between the opposite bead rings reaches a predetermined value L0 as shown in FIG. 6a. Then, at this interim state, reinforcing cords 34, that is, organic fiber cords or metal cords are applied approximately circularly on both side portions separated from each other with the crown portion of carcass band 31 therebetween, or more preferably a cord is continuously applied on each of the side portions in a spiral form to form thereby an insert ply.

Then, the distance between the opposite bead rings are caused to take a smaller predetermined value L1 as shown in FIG. 6b. Given that the cross-section of carcass band 31 has a constant length, when the expansion/deformation degree of the entire side portion is enhanced; a force is developed which causes the reinforcing cords 34 of insert ply 35 to elongate their radius; and thus the tension of the reinforcing cords 34 is increased as compared with the counterpart observed immediately after their application.

Through this operation, it is possible to cause the reinforcing cords which simply adhere to the surface of a coating rubber of carcass band 31 immediately after their application as shown in FIG. 6a, to be buried into the substance of the coating rubber, or more preferably to be forcibly buried into the substance of the coating rubber, accompanied with distinct deformations of carcass band 1, or more accurately of carcass cords as shown in FIG. 6b.

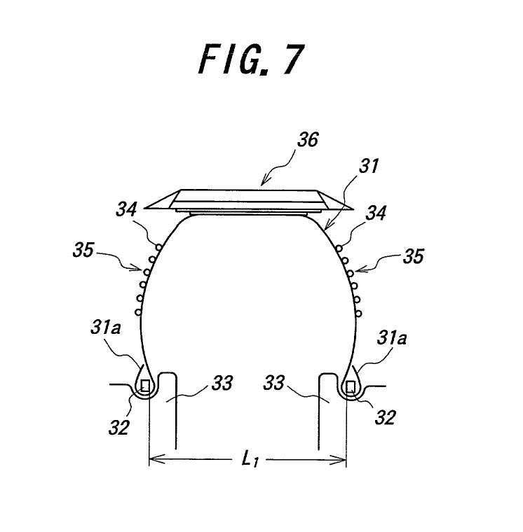

Further, with this embodiment, for example, a belt tread band 36 which has been formed on a belt tread band drum is properly positioned against the outer circumferential face of the crown portion of carcass band 31 to be fixed there as shown in FIG. 7, before the distance between the opposite bead rings is shortened to a predetermined value L1; and after the distance between the opposite beads has been shortened to a predetermined value L1, the crown portion of carcass band 31 is brought in contact with the inner face of belt tread band 36 for joining, and then firm adherence of the belt tread band 36 to the outer face of carcass band 31 is achieved by using a stitcher roll or the like.

The belt tread band 36 may be positioned against the outer face of a shaping drum, before the carcass band 1 is deformed by expansion as indicated in FIG. 6a, or after expansion/deformation as shown in FIG. 6a has been introduced but before formation of insert ply 35 is started.

A green tire having undergone a series of processes as described above, is subjected to successive steps generally known in the art, to complete the formation of green tire.

With a green tire formed as above, because it is possible to increase the tension of the reinforcing cords constituting the insert ply 35 as needed, or more preferably, in addition to above feature, to restrict the reinforcing cords 34 to a desired position, even when the tire is vulcanized and molded in a vulcanizing mold, the reinforcing cords 34 will securely withstand forces which may develop as a result of the deformation or spill of rubber substance during the above process, to maintain the initial, desired position and shape, thereby allowing a tire product where the cord tension and shape are maintained as designed to be produced.

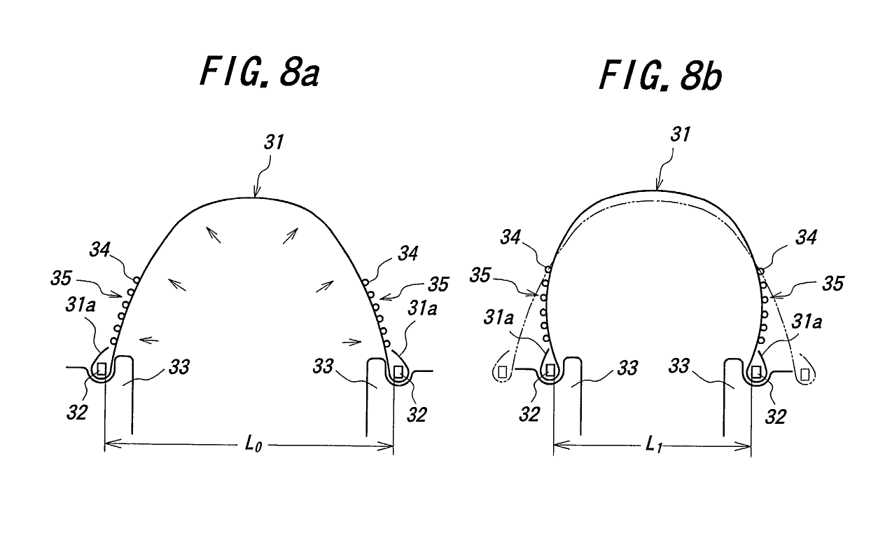

The above description has been given in relation to a case where the insert ply 35 is displaced considerably apart on the tire cross-section from the bead ring 32, but what has been described above similarly applies to a case where the insert ply is placed at a region close to the bead ring as shown in FIGS. 8a and 8b.

As discussed above, according to the present invention, it is possible to obtain a tire product where reinforcing cords are given a desired tension and the tire has a desired shape, by conferring a sufficiently high tension in accordance with a given requirement on the reinforcing cords constituting an insert ply prior to the vulcanization of the green tire, thereby preventing the reinforcing cords from being subject to displacements and/or deformations which otherwise could occur during vulcanization.

1. A method for manufacturing a pneumatic tire, wherein at least one kind of tire constitutive member is formed on an outer peripheral side of a carcass band, said method comprising the steps, for forming a green tire, of:
radially outwardly expanding a widthwise center portion of a substantially cylindrical carcass band; and
winding and joining an unvulcanized rubber strip onto an outer peripheral surface of the expanded carcass band, thereby forming said tire constitutive member.

2. A method according to claim 1, wherein the strip is formed to have a cross-section that is determined depending on the shape of the tire constitutive member, and the strip is wound such that, for each turn, a previously wound strip is superimposed at least partially by a successively wound strip, so as to allow a resulting lamination to form the constitutive member.

3. A method claim 1, wherein two or more kinds of unvulcanized rubber strips are wound one after another, to form a tire constitutive member.

4. A method according to claim 1, wherein the tire constitutive member includes any one of bead filler, sidewall, rubber chafer, buffer rubber, and belt undercushion.

5. A method for manufacturing a pneumatic tire, wherein at least one kind of tire constitutive member is formed on an outer peripheral side of a carcass band, said method comprising the steps, for forming a green tire, of:
radially outwardly expanding a widthwise center portion of a substantially cylindrical carcass band;
applying a belt layer onto an outer peripheral surface of the expanded carcass band; and
winding and joining at least one kind of unvulcanized rubber strip onto an outer peripheral surface of the belt layer, thereby forming said tire constitutive member.

6. A method according to claim 5, wherein the strip is formed to have a cross-section that is determined depending on the shape of the tire constitutive member, and the strip is wound such that, for each turn, a previously wound strip is superimposed at least partially by a successively wound strip, so as to allow a resulting lamination to form the constitutive member.

7. A method according to claim 5, wherein the tire constitutive member includes any one of tread, interlayer cushion between adjacent belt layers, and tread undercushion.

8. A method for manufacturing a pneumatic tire comprising combining a manufacturing method according to any one of claims 1 to 4, and another manufacturing method according to any one of claims 5 to 7 as appropriate in an appropriate order according to a given requirement.

9. A method for manufacturing a pneumatic tire including insert plies in its sidewall portions, wherein said insert plies are formed on an outer peripheral side of a carcass band, said method comprising the steps, for forming a green tire, of:
radially outwardly expanding a widthwise center portion of a substantially cylindrical carcass band having marginal portions to which bead rings are attached, by moving the bead rings axially toward each other;
forming the insert plies by applying, on both side portions of the carcass band separated from each other with the center portion therebetween, reinforcing cords to extend approximately in parallel with the circumferential direction; and
enhancing a degree of radial expansion of the carcass band by further moving the beard rings axially toward each other, so as to increase a tension of the reinforcing cords and thereby bring an outer face of a resultant crown portion into contact with a belt and a tread for joining.

10. A method according to claim 9, wherein the insert plies are formed by continuously winding a reinforcing cord in a spiral form.

11. A method according to claim 9, wherein the enhanced degree of expansion of the carcass band causes the reinforcing cords to be forcibly buried into a coating rubber of the carcass band.
